(19) United States
(12) Patent Application Publication
(10) Pub. No.: US 2004/0167960 A1
(43) Pub. Date: Aug. 26, 2004

(54) Network service interceptor

(76) Inventors: Jason Kinner, Marlton, NJ (US); Joseph J. Snyder, Shamon, NJ (US); Richard Friedman, Cherry Hill, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/371,561

(22) Filed: Feb. 21, 2003

(51) Int. Cl. G06F 15/16

(52) U.S. Cl. 709/203

(57) ABSTRACT

A servlet filter chain includes an interface and an interceptor coupled to the servlet filter chain interface. The interface is configured to receive a web-service request. The interceptor identifies when a received web-service request is designated for a particular servlet, and in response thereto, executes an instruction set corresponding to the particular servlet.

### BACKGROUND

The Internet is a world-wide collection of computing devices, networks, and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data packets from node to node across the various networks.

The World Wide Web (WWW) or web refers to the total set of interlinked hypertext documents residing on hypertext transfer protocol (HTTP) servers all around the world. Documents on the web, called pages or web pages, are written in hypertext mark-up language (HTML), identified by uniform-resource locators (URLs) that identify the particular machine and pathname by which a file can be accessed, and transmitted from node to node to the end user using HTTP. HTML-based pages contain standard text as well as formatting codes that indicate how the page should be displayed. A web site is a related group of these documents, associated files, scripts, subprocedures, databases, application software, etc. that are provided by an HTTP server coupled to one of the various networks. Web sites are accessible via a uniform resource locator (URL).

HTML is a scripting language used on the Internet. A web page constructed using HTML comprises text with accompanying “markups” that define text formats, such as, heading style, as well as image location, and links among other web page information. A link is a reference from one point in a page to another point in the same document or to a point in another document. A link may reference a point in a document located externally from the source document. That is, a link may reference a document or location within a document located on another web server.

A web service is any application that can exchange Simple Object Access protocol (SOAP) messages with another application across the web using standardized protocols. A web service is a wrapper for accessing servlets using HTTP or some other standard protocol that is both platform and language independent. Accordingly web services have client-side components and server side components.

On the client-side of the web service, computing devices use a client application program generally called a “web browser” and a communication link to the Internet to access a web site active on a web integrated server. Web browsers are software applications that locate, request, receive, and display content stored within a specific device coupled to the Internet. Web browsers display graphics including text. In addition, when web browsers receive data via a high-speed data link, web browsers can receive and process data rich media such as moving pictures and sound. In some embodiments, web-services provide an applet (i.e., a client application interface) that exposes the web service in some way through the client-side computing device.

On the server-side of the web service, servers coupled to the Internet receive, distribute, and process client requests using appropriately interfaced servlets. The servlets receive the request, which may include source and data information, gather any additional data required to perform the intended function, and process the request. Request results are then formatted and returned to the requesting client.

Web services allow for the quick integration of services built upon different technologies. Web services are modular, reusable software components that are created by exposing an application through a web service interface.

The ubiquitous nature of the Internet has led to the proliferation of various web services being provided on the Internet. Servlet technology provides web service developers with a simple consistent mechanism for extending the functionality of existing business systems accessible to end users via a web server. Servlets provide a component-based platform independent method for building web applications without the performance limitations inherent in the common gateway interface (CGI—a web scripting facility.)

Servlets are a popular component used in building web applications. Servlet containers are available for Apache Web Server, Microsoft IIS, and others. Servlet containers are generally a component of web and application servers, such as BEA System's Weblogic® Application Server, IBM's WebSphere, Sun Microsystems's ONE Web Server and ONE Application Server, among others. Weblogic® is the registered trademark of Weblogic, Inc. of San Francisco, Calif., U.S.A. WebSphere® is the registered trademark of International Business Machines, Inc. of Armonk, N.Y., U.S.A. Servlet containers integrate one or more servlets operational within an application server and communicatively couple the servlet(s) with client applications.

A successful integration of a previously developed application with a web service should expose the application to customers, partners, and in some cases employees through standard Internet technologies, such as extensible markup language (XML) and hypertext markup language (HTML). Moreover, the system should accomplish this goal while protecting the previous investment in already developed applications, some of which were introduced before the Internet.

Platform and language independent integration solutions, such as the Common Object Request Broker Architecture (CORBA), have been used to integrate many traditional and legacy server solutions into today's modern distributed computing environments. However, integration of these multi-tiered distributed computing environments with standard Internet technologies, such as XML and HTML, poses unique problems. First, the skills needed, as well as the goals and relative timing of the deployment cycles differ substantially at each tier. On one end of spectrum end-user applications, such as XML and HTML, are generally humanly readable and development cycles are relatively short. Conversely, on the other end of the spectrum, server integration solutions such as CORBA is a binary protocol that is not humanly readable and consequently more difficult to develop.

These drawbacks can be significant due to the investments already made in existing enterprise applications (including servlets) and the costs of training enterprise program developers to generate a more web-friendly paradigm.

### SUMMARY

A servlet filter chain includes an interface and an interceptor. The interceptor is coupled to the servlet filter chain interface. The interface receives web-service requests. The interceptor identifies when a received web-service request is designated for a particular servlet, and in response thereto, executes an instruction set corresponding to the particular servlet.

### BRIEF DESCRIPTION OF THE DRAWINGS

In representative embodiments a servlet filter and method for enhancing functionality of a servlet are illustrated by way of example and not limited by the implementations depicted in the following drawings. The components in the drawings are not necessarily to scale relative to each other, emphasis instead is placed upon clearly illustrating the principles of the servlet filter and the method. Moreover, in the drawings, like reference numerals designate corresponding parts throughout the several views.

FIG. 1 is a schematic diagram illustrating an embodiment of an environment in which the servlet filter resides.

FIG. 2 is a functional block diagram of an embodiment of the server computer of FIG. 1.

FIG. 3 is a schematic diagram of an embodiment of a network protocol stack that facilitates a web-services request.

FIG. 4 is a schematic diagram of an embodiment of a web-service.

FIG. 5 is a schematic diagram of an embodiment of the interceptor of FIG. 4.

FIG. 6 is a flow diagram illustrating an embodiment of a method for enhancing functionality to a servlet.

### DETAILED DESCRIPTION

In representative embodiments the servlet filter is implemented within a servlet filter chain inserted at the server-side between an Internet communication link and one or more servlets operable within the server computing devices in the web-service. The servlet filter chain includes an interceptor configured to recognize and process web-service requests. Web-service requests can be intercepted in accordance with a source parameter extracted from the header of packets received at an input to the servlet filter chain. Web-service requests can also be intercepted in accordance with an identified target servlet. Once intercepted, web-service requests are directed in accordance with the extracted source parameter, the target servlet, or both, to one or more appropriately configured instruction sets. The instruction sets include logic configured to enable functionality not provided in the target servlet. Accordingly, the system enables web-service programmers to modify present servlet functions without modifying the underlying source code associated with the target servlet. The system can be used by web-service programmers to add security, load management, features, or other enhancements to the functionality provided by a present suite of servlets. These additional features are enabled by transforming, redirecting, or denying web-service requests before they reach the target servlet. In some embodiments, the interceptor forwards a request to the target servlet or some other web-coupled device when it has completed execution of the instruction set.

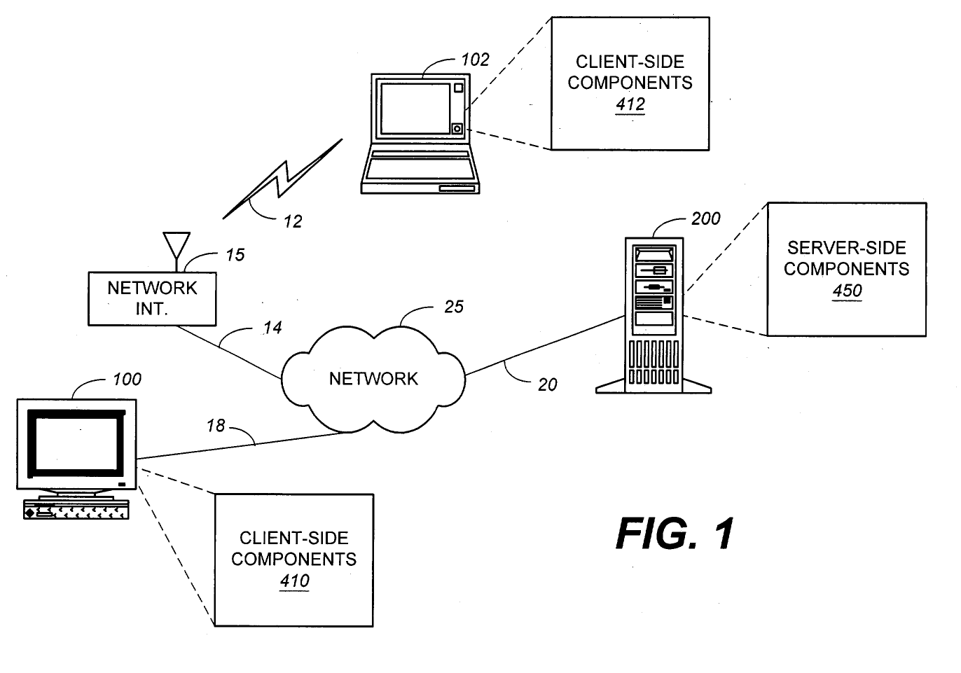

FIG. 1 is a schematic diagram illustrating an embodiment of an environment in which the servlet filter can reside. The environment comprises computing and communication devices integrated with a network 25. The servlet filter is implemented primarily in software within server-side components 450 operable within web server 200. Server-side components 450 include a communication link, one or more servlet filter chains, one or more servlets, as well as data abstraction layers, metadata storage, content storage, and one or more instruction sets, among other components.

Web server 200, which can be a personal computer (PC), a workstation, or a general-purpose computer, etc. is coupled to network 25 via connection 20. The environment further includes workstation 100 and laptop computer 102. In the embodiment illustrated in FIG. 1, workstation 100 is coupled to network 25 via connection 18 and laptop computer 102 is coupled to network 25 via wireless communication link 12, wireless network interface 15, and connection 14.

In preferred embodiments, the network 25 is the publicly accessible wide area network (WAN) commonly known as the Internet. In alternative embodiments, network 25 may be a proprietary network or even a local area network (LAN), such as an office network. Furthermore, the network 25 may be a wireless network or as in the illustrated environment of FIG. 1, network 25 may contain both wireless and wired components.

Wireless communication link 12 can be infrared (IR) or radio-frequency (RF) link capable of transferring information from laptop computer 102 to network interface 15. A variety of wireless communication interfaces and data transfer protocols support the communication of information between a portable device such as laptop computer 102 and an appropriately configured receiving device. For example, infrared data association protocol (IrDA), wireless fidelity (IEEE 802.11b wireless networking) or Wi-Fi, Bluetooth®, etc. each support wireless data transfers and can be used to implement communication link 12. Bluetooth® is the registered trademark of Bluetooth SIG, Inc.

Workstation 100 may be a personal computer or a general-purpose computing device located at, for example, a business office and connection 18 can be any connection for coupling workstation 100 to network 25. In a typical implementation, network 25 is the publicly accessible WAN commonly known as the Internet and connection 18 is one of a dial-up connection, a broadband connection, such as a digital subscriber line (DSL), or another high-speed connection such as a T1 connection.

The web server 200 is generally a dedicated computing device coupled to network 25 via a high-speed connection 20, that maintains, operates, or is otherwise coupled to a world wide web (WWW) location to provide functions associated with a web-service. In the illustrated embodiment, web server 200 maintains and operates server-side components 450. As described above, server-side components 450 may include a related group of documents, associated files, scripts, subprocedures, databases, metadata, application servlets, images, etc. Server-side components 450 operable or otherwise accessible via server 200 are accessible via client-side components 410, 412 operable or otherwise accessible via workstation 100 and laptop computer 102, respectively. Server-side components 450 communicate with client-side components 410, 412 using HTTP, FTP, among other communication protocols.

Client-side components 410, 412 include a communication link, various content management system modules (e.g., a library, a browser, access network transport, etc.) and Java™ 2 Platform, Enterprise Edition (J2EE) applications. While only two client-side computers (i.e., workstation 100 and laptop computer 102) are shown coupled to web server 200 via network 25 and the various wireless and wired connections, many additional computers and server computers may be coupled to network 25.

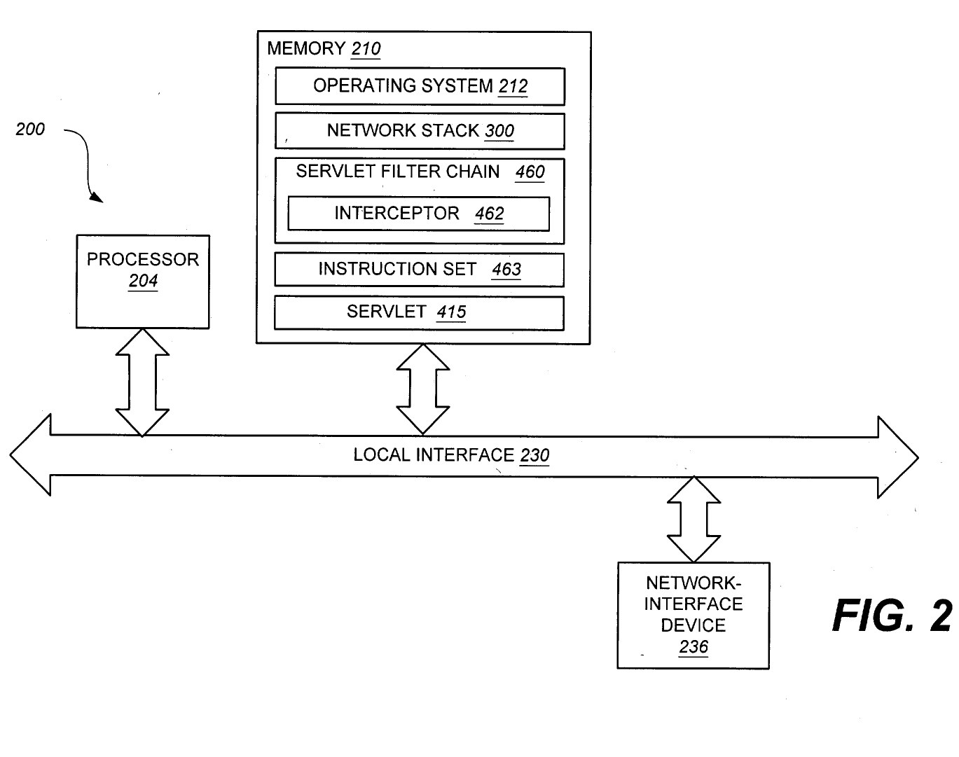

FIG. 2 is a functional block diagram of an embodiment of the general architecture of the web server 200 introduced in FIG. 1. Web server 200 includes a processor 204, a memory 210, and a network interface device 236 communicatively coupled to each other via local interface 230.

The local interface 230 can be, for example but not limited to, one or more buses or other wired or wireless connections, as is known in the art or may be later developed. Local interface 230 may have additional elements, which are omitted for simplicity, such as controllers, buffers (caches), drivers, repeaters, and receivers, to enable communications. Further, local interface 230 may include address, control, and/or data connections to enable appropriate communications among the aforementioned components of web server 200.

In the embodiment of FIG. 2, the processor 204 is a hardware device for executing software that can be stored in memory 210. The processor 204 can be any custom-made or commercially-available processor, a central-processing unit (CPU) or an auxiliary processor among several processors associated with the web server 200 and a semiconductor-based microprocessor (in the form of a microchip).

The memory 210 can include any one or combination of volatile memory elements (e.g., random-access memory (RAM, such as dynamic-RAM or DRAM, static-RAM or SRAM, etc.)) and nonvolatile-memory elements (e.g., read-only memory (ROM), hard drives, tape drives, compact-disk drives (CD-ROMs), etc.). Moreover, the memory 210 may incorporate electronic, magnetic, optical, and/or other types of storage media now known or later developed. Note that the memory 210 can have a distributed architecture, where various components are situated remote from one another, but accessible by processor 204.

The software in memory 210 may include one or more separate programs, elements, or modules, each of which comprises an ordered listing of executable instructions for implementing logical functions. In the example of FIG. 2, the software in memory 210 includes a servlet filter chain 460, which further includes interceptor 462. In addition, memory 210 includes operating system 212, network stack 300, instruction set 463, and servlet 415. Network stack 300, servlet filter chain 460, interceptor 462, instruction set 463, and servlet 415 function as a result of and in accordance with operating system 212. Scheduling, input-output control, file and data management, memory management, and communication control and related services are also provided by operating system 212. In addition to the modules illustrated in FIG. 2, memory 210 can include one or more commercially available applications as well as proprietary applications (not shown).

As described above, servlet filter chain 460 and interceptor 462 are applied to one or more web-service requests to provide additional functions unavailable in servlet 415 without modifying servlet 415. Web-service requests can be intercepted in accordance with a source parameter extracted from the header of packets received at an input to the servlet filter chain 460. Web-service requests can also be intercepted in accordance with a target servlet, such as servlet 415. Once intercepted, web-service requests are directed in accordance with the extracted source parameter, the target servlet, or both, to one or more appropriately configured functional modules. In the embodiment illustrated in FIG. 2, the functional modules are provided in instruction set 463. Accordingly, the servlet filter chain 460 enables web-service programmers to add and/or modify functionality present in servlet 415 without modifying the underlying source code associated with servlet 415.

The servlet filter chain 460 can be used by web-service programmers to add security, load management, features, or other enhancements to the functionality provided by a present suite of servlets. These additional features are enabled by transforming, redirecting, or denying web-service requests before they are forwarded to servlet 415. In some embodiments, the instruction set 463 forwards a web-service request to servlet 415 or some other web-coupled device in accordance with executable instructions contained therein.

As further illustrated in FIG. 2, the web server 200 is configured with a network interface device 236. The network interface device 236 can include an IR port and/or a RF port along with various wired ports such as an Ethernet port (not shown for simplicity of illustration). Regardless of the network interface medium, network interface device 236 communicates with the processor 204 via local interface 230 and external network coupled devices using an appropriate data transfer protocol.

When the web server 200 is in operation, the processor 204 is configured to execute software stored within the memory 210, to communicate data to and from the memory 210, and to generally control operations and functions pursuant to the software. The operating system 212, servlet filter chain 460, and interceptor 462, in whole or in part, but typically the latter, are read by the processor 204, perhaps buffered within the processor 204, and then executed.

It should be understood that the servlet filter chain 460 and interceptor 462 can be embodied in any computer-readable medium for use by or in connection with an instruction-execution system, apparatus, or device, such as a computer-based system, processor-containing system, or other system that can fetch the instructions from the instruction-execution system, apparatus, or device, and execute the instructions. In the context of this disclosure, a “computer-readable medium” can be any means that can store, communicate, propagate, or transport a program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium now known or later developed. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Those skilled in the art will understand that various portions of the servlet filter chain 460 and the interceptor 462 can be implemented in hardware, software, firmware, or combinations thereof. In separate embodiments, the servlet filter chain 460 and the interceptor 462 are implemented using a combination of hardware and software or firmware that is stored in memory and executed by a suitable instruction-execution system. If implemented solely in hardware, as in an alternative embodiments, the servlet filter chain 460 and the interceptor 462 can be separately implemented with any or a combination of technologies which are well-known in the art (e.g., discrete-logic circuits, application-specific integrated circuits (ASICs), programmable-gate arrays (PGAs), field-programmable gate arrays (FPGAs), etc.), and/or later developed technologies. In preferred embodiments, the functions of the servlet filter chain 460 and the interceptor 462 are implemented in a combination of software executed and stored under the control of the web server 200. It should be noted, however, that neither the servlet filter chain 460 nor the interceptor 462 are dependent upon the nature of the underlying computing device and/or upon the operating system 212 in order to accomplish their respective designated functions.

It will be well understood by one having ordinary skill in the art, after having become familiar with the teachings of the servlet filter chain 460 and the interceptor that these modules may be written in a number of programming languages now known or later developed.

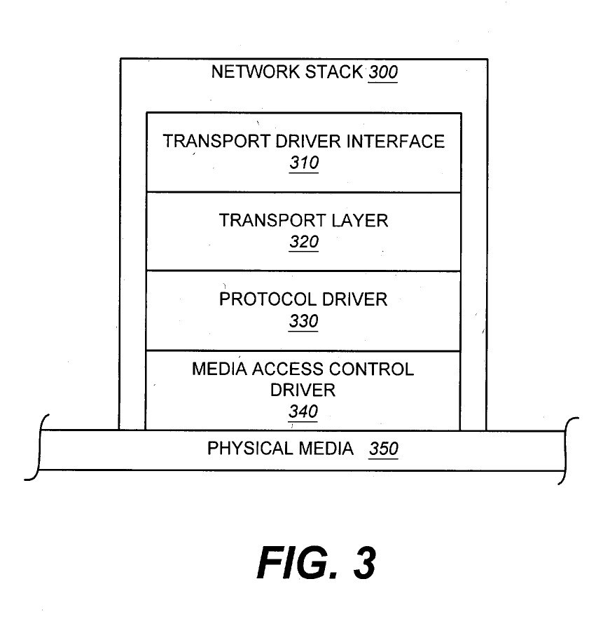

Network stack 300 is illustrated in FIG. 3 to facilitate an understanding of the interceptor 462. However, it should be understood that the interceptor 462 is not limited to the implementation illustrated in FIG. 3.

Network stack 300 includes a transport driver interface 310, a transport layer 320, a protocol driver 330, and a media access control driver 340 that interfaces with physical media 350 to facilitate the transfer of web-service requests and responses. Transport driver interface 310 integrates the transport driver 320 with higher-level file-system drivers. Accordingly, transport driver interface 310 enables operating system drivers, such as network redirectors, to activate a session, or bind with the appropriate protocol driver 330. In this way, a redirectorcan access the appropriate protocol, for example, user datagram protocol (UDP), TCP, netbios extended user interface (NetBEUI) among other network or transport layer protocols, thereby making the redirector protocol independent.

The protocol driver 330 creates data packets that are sent from the computing system (e.g., workstation 100 and/or laptop computer 102) hosting the network stack 300 to another computer such as web server 200 on network 25 via physical media 350. Typical protocols supported by network stack 300 include NetBEUI, TCP/IP, NWLink, Data Link Control (DLC) and Appletalk®, among other transport and network protocols. Appletalk® is the registered trademark of Apple Computer, Inc. of Cupertino, Calif., U.S.A. Media access control driver 340, for example, an Ethernet driver, a token ring driver or other networking driver, provides appropriate formatting and interfacing with the physical media 350 such as category 5 wiring, a coaxial cable or some other medium.

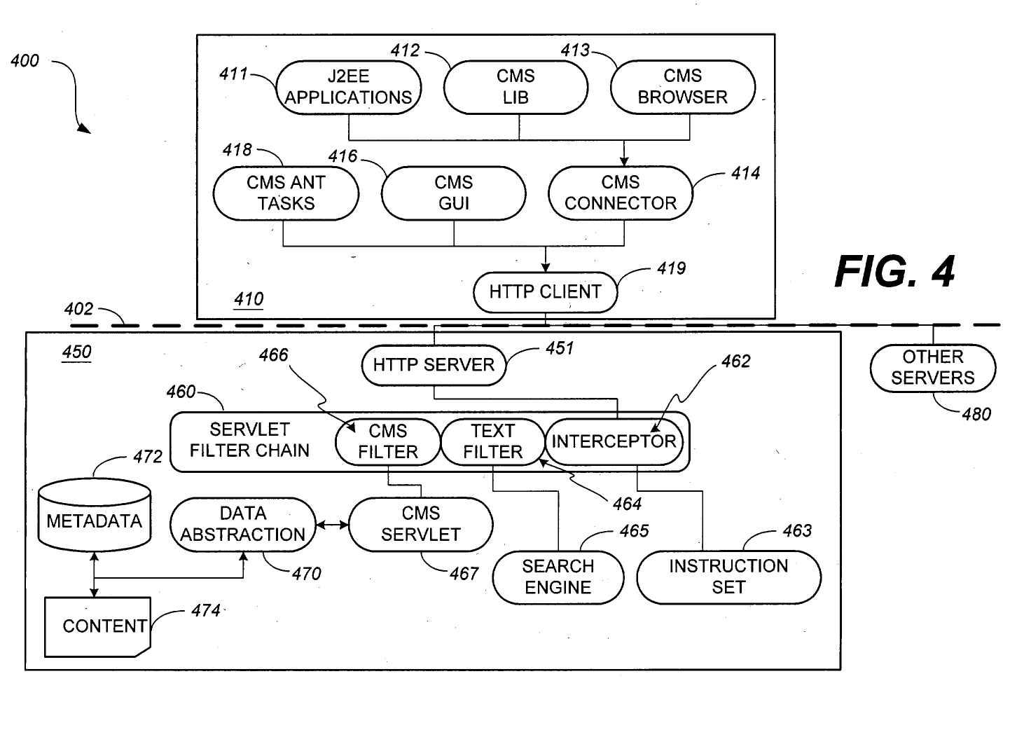

FIG. 4 is a schematic diagram illustrating the various modules in an embodiment of a web-service 400. In the embodiment illustrated in FIG. 4, web-service 400 includes client-side components 410 and server-side components 450 and other servers 480 coupled via network infrastructure 402. As described above, client-side components 410 are operable on workstation 100, laptop computer 102, and perhaps other computers. Client-side components 410 include a HTTP client interface 419 for establishing a network communication session via the network infrastructure 402, as well as a host of content management system (CMS) interface modules. As illustrated in FIG. 4, the CMS interface modules comprise a CMS connector 414, a CMS graphical-user interface (GUI) 416, and a CMS access network transport (ANT) tasks module 418 coupled to the HTTP client interface 419.

CMS connector 414 serves as an interface between J2EE applications 411, CMS library applications 412, and a CMS browser 413. J2EE applications 411 and CMS library applications 412 work together with the CMS browser 413 to expose the functionality available in CMS servlet 467, search engine 465, and instruction set 463 to an operator of the workstation 100 or laptop computer 102.

As described above, server-side components 450 are operable on web server 200 and perhaps other servers 480. Server-side components 450 include a HTTP server 451, a servlet filter chain 460, as well as instruction set 463, search engine 465, and CMS servlet 467. HHTP server 451 establishes a network communication session via network infrastructure 402. Servlet filter chain 460 receives and processes web-service requests from HTTP server 451. In this regard, processing can include parsing of HTTP packets to extract header information to determine the identity of the web-service client and identifying one or more service modules required to respond appropriately to the web-service request. Processing may further include execution management for various tasks and functions associated with instruction set 463, search engine 465, and CMS servlet 467. For example, when interceptor 462 identifies a web-service request that needs functionality provided by instruction set 463, the interceptor 462 may forward data, commands, pointers, etc. to the instruction set 463 and monitor execution of one or more functional modules until completion. Upon completion, interceptor 462, in accordance with the web-service request may forward the request to other filters in the servlet filter chain 460 or may redirect the web-service request to other servers 480 at that time as may be necessary to complete tasks identified in the request.

In one mode of operation, among others, the interceptor 462 is configured to identify web-service requests designated to interface with CMS servlet 467. Once identified, the interceptor 462 directs the web-service request to one or more appropriately configured function modules within instruction set 463. In this way, the servlet filter chain 460 enables functionality not provided in the CMS servlet 467 without modifying the servlet. In another mode of operation, the interceptor 462 is configured to identify the source of the web-service request and redirect or otherwise transform the web-service request in accordance with one or more source parameters extracted from the request. In this second mode of operation, the interceptor 462 provides the capability of adding security measures and other functionality prior to executing functions provided in CMS servlet 467. In another operational mode, the interceptor 462 is configured to intercept, direct, and manage the execution of one or more function modules in accordance with both the web-client and the target servlet (e.g., CMS servlet 467).

Servlet filter chain 460 includes an interceptor 462, a text filter 464, and a CMS filter 466. However, it should be noted that the servlet filter chain 460 is not limited to this embodiment. For example, server-side components 450 will often comprise a plurality of various CMS servlets with each providing a function in support of aspects of web-service 400. While illustrated as a hierarchical series of an interceptor 462 and various filters, servlet filter chain may comprise other architectures or sequences as desired.

As further illustrated in the embodiment of FIG. 4, CMS servlet 467 is integrated with a data abstraction interface 470 that exposes a metadata database 472 and content 474 to CMS servlet. Metadata is data describing other data such as content 474. Metadata processing is an important aspect of applications that attempt to expose human-readable assets to computing devices in a way in which the computing devices can meaningfully act upon the content 474.

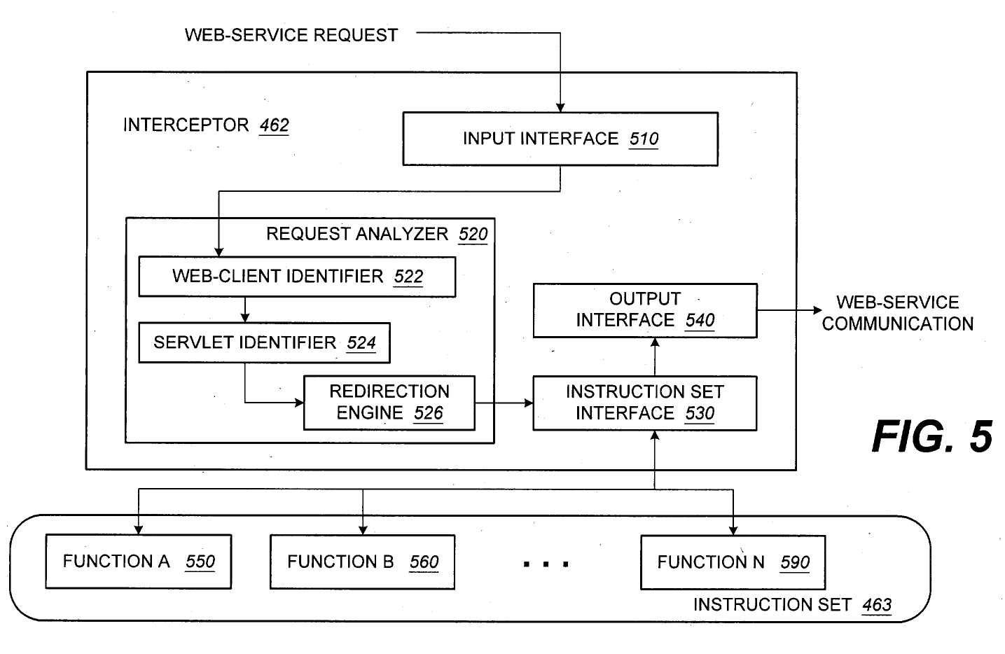

FIG. 5 is a schematic diagram of the interceptor 462 and the instruction set 463 of FIG. 4. As shown in FIG. 5, interceptor 462 receives web-service requests, interacts with instruction set 463 and forwards web-service communications. Specifically, interceptor 462 receives web-service requests at input interface 510, which forwards the requests to request analyzer 520. Request analyzer 520 parses the web-service request using a web-client identifier 522 and a servlet identifier 524. Web-client identifier 522 uses the parsed information from the web-service request to identify the client responsible for generating the web-service request. Servlet identifier 524 uses the parsed information from the web-service request to identify a target servlet that the client desires to use.

Redirection engine 526 includes logic configured to determine an appropriate function within instruction set 463 in accordance with a source identifier, as provided by web-client identifier 522. An appropriate function can also be determined in accordance with a target servlet identified by servlet identifier 526. In still other embodiments, redirection engine 526 identifies an appropriate function selected from a set of available functions provided in instruction set 463 in accordance with both the identified web-client and target servlet. Redirection engine 526 forwards a memory pointer or some other index to the instruction set 463 via instruction set interface 530 identifying one or more functions, such as function A 550, function B 560, . . . , and function N 590 that are to be executed. In some embodiments, redirection engine 526 is configured to order the execution of a sequence of several functions selected from the set of available functions in instruction set 463. In the illustrated embodiment, once the executable instructions associated with the one or more selected functions have been processed, the interceptor 462 receives information via instruction set interface 530 and forwards a web-service communication via output interface 540 coupled at an output of instruction set interface 530. Web-service communications include data (results), commands, transformed requests, as well as other web-service responses.

In alternative embodiments, input interface 510 and output interface 540 may be combined in a single interface capable of receiving web-service requests and delivering web-service communications. In addition, instruction set 463 can be configured with a separate mechanism for providing results in the form of data, commands, transformed requests etc. to other locations.

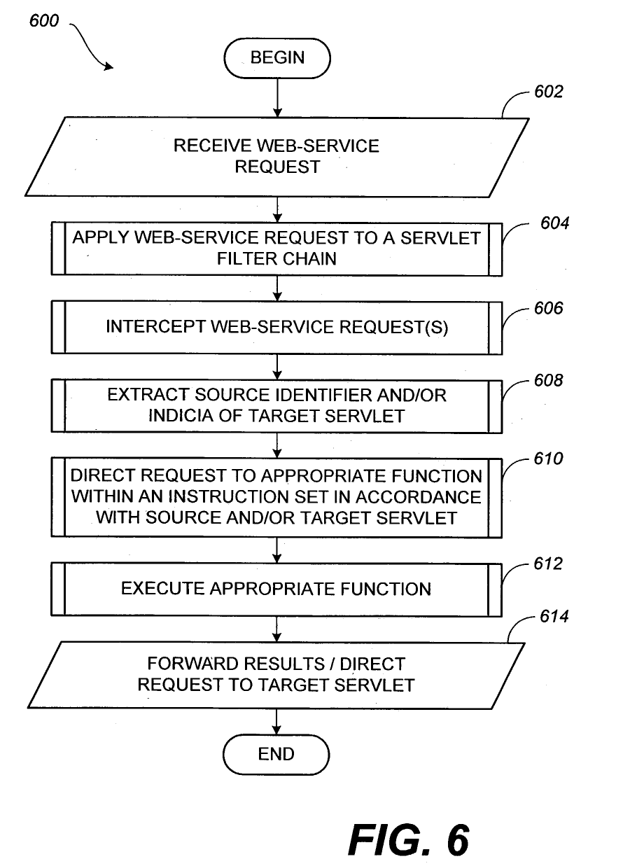

Any process descriptions or blocks in the flow diagram of FIG. 6 should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of providing web-services.

Reference is now directed to FIG. 6, which presents an embodiment of a method 600 for enhancing functionality of a servlet 415. Method 600 begins with input block 602 where server-side components 450 receive a web-service request. As indicated in block 604, the received web-service request is applied at a servlet filter chain 460. Next, as illustrated in block 606, the received web-service request is intercepted. As described above, an interceptor 462 within the servlet filter chain 460 can be configured to extract source and/or target information from the header of a packet forming the received web-service request. Source information includes indicia identifying the client that issued the web-service request. Target information includes an indication of the designated servlet that the web-service request is attempting to use.

Next, as indicated in block 608, the interceptor 462 extracts a source identifier and/or indicia of a target servlet that the client is trying to access. Once, the interceptor 462 has identified the source or the target servlet, or in some cases both, the interceptor 462 directs the web-service request to an appropriate function within instruction set 463, as shown in block 610. Thereafter, in block 612, the interceptor 462 executes the appropriate function. Lastly, as indicated in output block 614, the interceptor 462 forwards results and in some cases may direct the web-service request to the target servlet or some other designated location. In some embodiments, the appropriate function includes instructions that transform the original web-service request before forwarding the request either to the target servlet or some other location.

We claim:

1. A computer-readable medium having stored thereon a first executable instruction set, the first executable instruction set, when executed by a processor, directs the processor to perform a method, comprising:
intercepting a service request within a servlet filter chain, wherein the service request is designated for processing by a servlet coupled to the servlet filter chain;
identifying a second instruction set responsive to the service request; and
executing the second instruction set.

2. The computer-readable medium of claim 1, wherein identifying a second instruction set further comprises performing a direct call to a source code in accordance with the second instruction set.

3. The computer-readable medium of claim 1, wherein intercepting a service request is preceded by:
establishing a communication session with a client.

4. The computer-readable medium of claim 3, wherein establishing a communication session further comprises:
generating a response to the, service request.

5. The computer-readable medium of claim 1, wherein identifying a second instruction set further comprises extracting a source parameter from the service request.

6. The computer-readable medium of claim 1, wherein identifying a second instruction set further comprises:
verifying the identity of a client; and
forwarding the service request to the servlet.

7. The computer-readable medium of claim 1, wherein executing the second instruction set comprises transforming the service request.

8. The computer-readable medium of claim 1, wherein executing the second instruction set comprises redirecting the service request.

9. A method for enhancing the functionality of a servlet, comprising:
receiving a web-service request that contains information designated for processing by the servlet;
using a servlet filter to intercept the web-service request; and
responding to the web-request in accordance with an instruction set.

10. The method of claim 9, wherein using a servlet filter further comprises extracting a source parameter from the web-service request.

11. The method of claim 10, further comprising:
identifying the instruction set in response to the source parameter.

12. The method of claim 11, wherein identifying the instruction set further comprises:
verifying the identity of a web-client; and
forwarding the web-service request to the servlet.

13. The method of claim 9, wherein receiving a web-service request further comprises establishing a communication session with a web-client.

14. The method of claim 9, wherein responding to the web-service request further comprises transforming the web-service request.

15. The method of claim 9, wherein responding to the web-service request further comprises denying the web-service request.

16. The method of claim 9, wherein responding to the web-service request further comprises redirecting the web-service request.

17. A servlet filter chain, comprising:
an interface configured to receive a web-service request;
an interceptor coupled to the interface, the interceptor configured to:
identify when the web-service request is designated for a particular servlet; and in response thereto,
execute an instruction set corresponding to the particular servlet.

18. The servlet filter chain of claim 17, wherein the first interface receives the web-service request by:
establishing a communication session with a web-client.

19. The servlet filter chain of claim 17, wherein the interceptor executes an instruction set in accordance with source information extracted from the web-service request.

20. The servlet filter chain of claim 17, further comprising:
a second interface that forwards the web-service request to the particular servlet after execution of the instruction set.

21. A servlet filter chain, comprising:
means for receiving a web-service request;
means for intercepting a web-service request designated for a particular servlet; and in response thereto,
means for executing an instruction set corresponding to the particular servlet.

22. The servlet filter chain of claim 21, wherein the means for receiving a web-service request comprises an interface.

23. The servlet filter chain of claim 21, further comprising:
means for establishing a communication session with a web-client.

24. The servlet filter chain of claim 21, wherein the means for executing executes an instruction set in accordance with source information extracted from the web-service request.

25. The servlet filter chain of claim 24, further comprising:
means for forwarding the web-service request to the particular servlet after the means for executing executes the instruction set.
